(19) United States
(12) Patent Application Publication
(10) Pub. No.: US 2025/0199546 A1
(43) Pub. Date: Jun. 19, 2025

(54) SYSTEM, DEVICE, MOVING OBJECT, AND CONTROL METHOD

(71) Applicant: TOYOTA JIDOSHA KABUSHIKI KAISHA, Toyota-shi (JP)

(72) Inventor: Kento IWAHORI, Nagoya-shi (JP)

(21) Appl. No.: 18/956,443

(22) Filed: Nov. 22, 2024

(30) Foreign Application Priority Data
Dec. 13, 2023 (JP) 2023-209741

(51) Int. Cl. G05D 1/86; G05D 1/249; G05D 1/65; G05D 107/70; G05D 109/10

(52) U.S. Cl. CPC G05D 1/86; G05D 1/249; G05D 1/651; G05D 2107/70; G05D 2109/10

(57) ABSTRACT

A system includes: a plurality of functional units each configured to perform a process for controlling unmanned driving of a moving object; a first time management unit configured to manage a first time that is used in a first functional unit, the first functional unit being part of the functional units; a second time management unit configured to manage a second time that is used in a second functional unit, the second functional unit being a different one of the functional units from the first functional unit; a difference degree detection unit configured to detect a degree of difference between the first time and the second time; and an execution unit configured to execute either or both of the following operations when the degree of difference is equal to or larger than a predetermined threshold: warning an administrator, and reducing a moving speed of the moving object.

### CROSS-REFERENCE TO RELATED APPLICATION

This application claims priority to Japanese Patent Application No. 2023-209741 filed on Dec. 13, 2023, incorporated herein by reference in its entirety.

### BACKGROUND

### 1. Technical Field

The present disclosure relates to systems.

### 2. Description of Related Art

A technique of driving a vehicle by unmanned driving in a vehicle manufacturing process is known in the art (for example, Japanese Unexamined Patent Application Publication (Translation of PCT Application) No. 2017-538619 (JP 2017-538619 A)).

### SUMMARY

Such unmanned driving of a vehicle is implemented according to control signals that are generated through processes performed in various functional units included in a system. In the case where there is a plurality of times managed independently of each other and the functional units perform the processes using different times from each other, there is a possibility that the accuracy of the control signals that implement the unmanned driving may decrease due to the lag between the times used in the functional units.

The present disclosure can be implemented in the following aspects.

(1) One aspect of the present disclosure provides a system. The system includes: a plurality of functional units each configured to perform a process for controlling unmanned driving of a moving object; a first time management unit configured to manage a first time that is used in a first functional unit, the first functional unit being part of the functional units; a second time management unit configured to manage a second time that is used in a second functional unit, the second functional unit being a different one of the functional units from the first functional unit; a difference degree detection unit configured to detect a degree of difference between the first time and the second time; and an execution unit configured to execute either or both of the following operations when the degree of difference is equal to or larger than a predetermined threshold: warning an administrator, and reducing a moving speed of the moving object.

According to the system of this aspect, the degree of difference between the first time and the second time is detected, and when the degree of difference is equal to or larger than the threshold, either or both of the following operations is performed: warning the administrator, and reducing the moving speed of the moving object. This reduces the possibility that the accuracy of unmanned driving control may decrease due to control of the moving object being continued with the degree of difference being large.

(2) In the above aspect, the functional units may include: a calculation unit configured to acquire either or both of a position of the moving object and a direction of the moving object by using a detection result regarding the moving object acquired from an external sensor located outside the moving object; a control value generation unit configured to generate, using either or both of the position of the moving object and the direction of the moving object, a control value for controlling the moving object; and a transmission unit configured to send the control value to the moving object.

The system of this aspect reduces the possibility that the accuracy of unmanned driving control may decrease in the system including the calculation unit, the control value generation unit, and the transmission unit.

(3) In the above aspect, the system may further include a plurality of control devices. A first control device that is one of the control devices may include the first functional unit, and a second control device that is a different one of the control devices from the first control device may include the second functional unit.

According to the system of this aspect, the first control device includes the first functional unit, and the second control device includes the second functional unit. This reduces the possibility that the accuracy of unmanned driving control may decrease due to the difference in time that occurs between the different control devices.

(4) Another aspect of the present disclosure provides a device that is used in the system according to (1) or (2). The device includes: the difference degree detection unit; and the execution unit.

According to the device of this aspect, the degree of difference between the first time and the second time is detected, and when the degree of difference is equal to or larger than the threshold, either or both of the following operations is performed: warning the administrator, and reducing the moving speed of the moving object. This reduces the possibility that the accuracy of unmanned driving control may decrease due to control of the moving object being continued with the degree of difference being large.

(5) Still another aspect of the present disclosure provides a moving object configured to travel by unmanned driving. The moving object includes: a plurality of functional units configured to control the unmanned driving; a first time management unit configured to manage a first time that is used in a first functional unit, the first functional unit being part of the functional units; a second time management unit configured to manage a second time that is used in a second functional unit, the second functional unit being a different one of the functional units from the first functional unit; a difference degree detection unit configured to detect a degree of difference between the first time and the second time; and an execution unit configured to execute either or both of the following operations when the degree of difference is equal to or larger than a predetermined threshold: warning an administrator, and reducing a moving speed of the moving object.

According to the moving object of this aspect, the degree of difference between the first time and the second time is detected, and when the degree of difference is equal to or larger than the threshold, either or both of the following operations is performed: warning the administrator, and reducing the moving speed of the moving object. This reduces the possibility that the accuracy of unmanned driving control may decrease due to control of the moving object being continued with the degree of difference being large.

(6) Yet another aspect of the present disclosure provides a control method for controlling a moving object in a system including a plurality of functional units each configured to perform a process for controlling unmanned driving of the moving object. This control method include: detecting a degree of difference between a first time and a second time, the first time being a time that is used in a first functional unit, the first functional unit being part of the functional units, the second time being a time that is used in a second functional unit, and the second functional unit being a different one of the functional units from the first functional unit; and executing either or both of the following operations when the degree of difference is equal to or larger than a predetermined threshold: warning an administrator, and reducing a moving speed of the moving object.

According to the control method of this aspect, the degree of difference between the first time and the second time is detected, and when the degree of difference is equal to or larger than the threshold, either or both of the following operations is performed: warning the administrator, and reducing the moving speed of the moving object. This reduces the possibility that the accuracy of unmanned driving control may decrease due to control of the moving object being continued with the degree of difference being large.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a configuration of a system according to a first embodiment;

FIG. 2 is a block diagram illustrating a configuration of a vehicle according to the first embodiment;

FIG. 3 is a block diagram illustrating a configuration of a recognition server according to the first embodiment;

FIG. 4 is a block diagram illustrating a configuration of a control server according to the first embodiment;

FIG. 5 is a block diagram illustrating a configuration of a vehicle communication server according to the first embodiment;

FIG. 6 is a flowchart illustrating a processing procedure of travel control of the vehicle according to the first embodiment;

FIG. 7 is a flowchart illustrating a procedure of processing executed in the server group according to the first embodiment;

FIG. 8 is a block diagram illustrating a configuration of a control system according to the second embodiment;

FIG. 9 is a flow chart showing a process sequence of driving control of vehicles according to the second embodiment; and

FIG. 10 is a flowchart illustrating a procedure of a process executed in the vehicle control device according to the second embodiment.

### DETAILED DESCRIPTION OF EMBODIMENTS

### A. First Embodiment

### A-1. System Configuration:

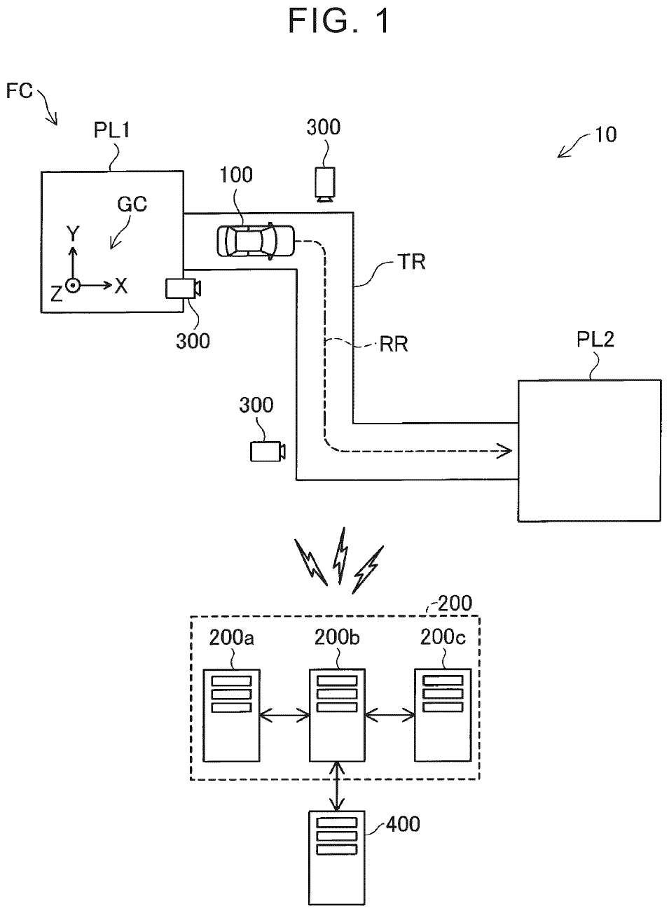

FIG. 1 is a conceptual diagram illustrating a configuration of a system 10 according to a first embodiment. The system 10 includes one or more vehicles 100 as a moving object, a server group 200, and one or more external sensors 300.

In the present disclosure, “moving object” means a movable object, and is, for example, a vehicle or an electric vertical takeoff and landing machine (a so-called flying vehicle). The vehicle may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles include battery electric vehicle (BEV), gasoline-powered vehicles, hybrid electric vehicle, and fuel cell electric vehicle. When the moving object is other than the vehicle, the expressions of “vehicle” and “vehicle” in the present disclosure can be appropriately replaced with “moving object”, and the expression of “traveling” can be appropriately replaced with “moving”.

The vehicle 100 is configured to be able to travel by unmanned driving. The term “unmanned driving” means driving that does not depend on the traveling operation of the passenger. The traveling operation means an operation related to at least one of “running”, “turning”, and “stopping” of the vehicle 100. The unmanned driving is realized by automatic or manual remote control using a device located outside the vehicle 100 or by autonomous control of the vehicle 100. A passenger who does not perform the traveling operation May be on the vehicle 100 traveling by the unmanned driving. The passenger who does not perform the traveling operation includes, for example, a person who is simply seated on the seat of the vehicle 100 and a person who performs a work different from the traveling operation such as an assembling operation, an inspection operation, and an operation of switches while riding on the vehicle 100. Driving by the traveling operation of the occupant is sometimes referred to as “manned driving”.

Herein, “remote control” includes “full remote control” in which all of the operations of the vehicle 100 are completely determined from the outside of the vehicle 100, and “partial remote control” in which a part of the operations of the vehicle 100 is determined from the outside of the vehicle 100. Also, “autonomous control” includes “full autonomous control” and “partial autonomous control”. The fully autonomous control is a control in which the vehicle 100 autonomously controls its own operation without receiving any information from a device outside the vehicle 100. The partial autonomous control is a control in which the vehicle 100 autonomously controls its own operation using information received from a device outside the vehicle 100. In the following description, control for traveling of the vehicle 100 realized by remote control or autonomous control is also referred to as “traveling control”. The travel control corresponds to “movement control” in the present disclosure.

In the present embodiment, the system 10 is used in a factory FC for manufacturing the vehicles 100. The reference coordinate system of the factory FC is a global coordinate system GC. That is, any position in the factory FC is represented by the coordinates of X, Y, Z in the global coordinate system GC. The factory FC includes a first location PL1 and a second location PL2. The first location PL1 and the second location PL2 are connected by a track TR on which the vehicles 100 can travel. In the factory FC, a plurality of external sensors 300 are installed along the track TR. The positions of the external sensors 300 in the factory FC are adjusted in advance. The vehicles 100 travel through the track TR from the first location PL1 to the second location PL2 by unmanned driving.

The external sensor 300 is a sensor located outside the vehicle 100, and acquires information related to the vehicle 100. The external sensor 300 in the present embodiment is a sensor that captures the vehicle 100 from the outside of the vehicle 100. Specifically, the external sensor 300 is constituted by a camera. The camera as the external sensor 300 captures a captured image including the vehicle 100, and outputs the captured image as a detection result. The external sensor 300 includes a communication device (not shown), and can communicate with other devices such as the server group 200 by wired communication or wireless communication.

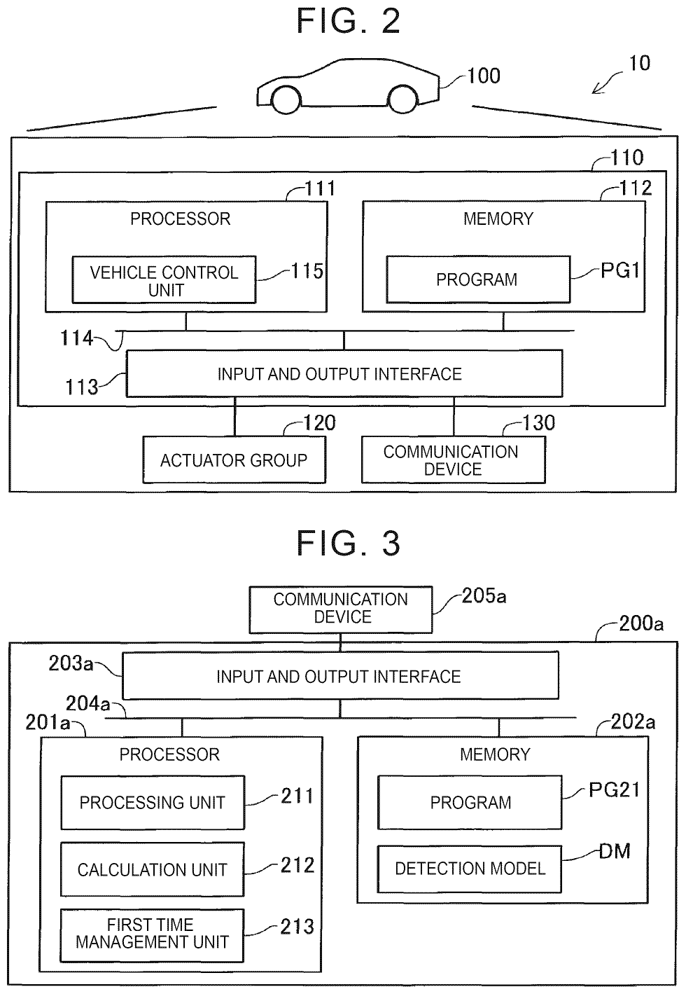

FIG. 2 is a block diagram illustrating a configuration of a vehicle according to the first embodiment. The vehicle 100 includes a vehicle control device 110 for controlling each unit of the vehicle 100, an actuator group 120 including one or more actuators driven under the control of the vehicle control device 110, and a communication device 130 for wirelessly communicating with an external device such as the server group 200. The actuator group 120 includes an actuator of a driving device for accelerating the vehicle 100, an actuator of a steering device for changing a traveling direction of the vehicle 100, and an actuator of a braking device for decelerating the vehicle 100. In addition, the vehicle 100 may include various sensors (not shown) such as a vehicle speed sensor and a yaw rate sensor.

The vehicle control device 110 includes a computer including a processor 111, a memory 112, an input/output interface 113, and an internal bus 114. The processor 111, the memory 112, and the input/output interface 113 are bidirectionally communicably connected via an internal bus 114. An actuator group 120 and a communication device 130 are connected to the input/output interface 113. The processor 111 executes the program PG1 stored in the memory 112 to realize various functions including functions as the vehicle control unit 115.

The vehicle control unit 115 controls the actuator group 120 to cause the vehicle 100 to travel. The vehicle control unit 115 can cause the vehicle 100 to travel by controlling the actuator group 120 using the travel control signal received from the server group 200. The travel control signal is a control signal for causing the vehicle 100 to travel. In the present embodiment, the travel control signal includes the acceleration and the steering angle of the vehicle 100 as parameters. In other embodiments, the travel control signal may include the speed of the vehicle 100 as a parameter in place of or in addition to the acceleration of the vehicle 100.

The server group 200 includes a recognition server 200a, a control server 200b, and a vehicle communication server 200c. The recognition server 200a, the control server 200b, and the vehicle communication server 200c respectively implement processes differing from each other for the unmanned driving of the vehicle 100. Each of the recognition server 200a, the control server 200b, and the vehicle communication server 200c corresponds to a “control device” in the present disclosure.

FIG. 3 is a diagram illustrating a configuration of a recognition server 200a according to the first embodiment. The recognition server 200a executes processing related to recognition of the vehicle 100 among processing for controlling unmanned driving of the vehicle 100. The recognition server 200a includes a computer including a processor 201a, a memory 202a, an input/output interface 203a, and an internal bus 204a.

The processor 201a, the memory 202a, and the input/output interface 203a are connected to each other via an internal bus 204a so as to be capable of two-way communication. A communication device 205a for communicating with various devices outside the recognition server 200a is connected to the input/output interface 203a. The communication device 205a can communicate with the vehicle 100 through wireless communication, and can communicate with the external sensor 300, the control server 200b, the vehicle communication server 200c, and the time management server 400, which will be described later, through wired communication or wireless communication.

The processor 201a functions as a processing unit 211, a calculation unit 212, and a first time management unit 213 by executing a program PG21 stored in a memory 202a.

The processing unit 211 acquires a captured image from the external sensor 300, performs preprocessing for detecting the vehicle 100, and outputs a processed image. The processing unit 211 executes, for example, distortion correction processing, rotation processing, and mask processing of a captured image as preprocessing. By performing such preprocessing, it is possible to improve the accuracy of detection of the vehicle 100 to be executed later. Note that the preprocessing may not be executed, and in such cases, the processor 201a may not include the processing unit 211.

The calculation unit 212 acquires the processed image preprocessed by the processing unit 211, acquires the position and the direction of the vehicle 100 using the processed image, and outputs the position and the direction of the vehicle 100. In the following description, the position and orientation of the vehicle 100 are also referred to as “vehicle position information”. Details of the processing executed by the calculation unit 212 will be described later. Note that the calculation unit 212 may acquire only one of the position and the direction of the vehicle 100 as the vehicle position information. In such a case, the other of the position and the orientation of the vehicle 100 may be specified by using the travel history of the vehicle 100 or the like. Further, the calculation unit 212 may directly acquire the captured image from the external sensor 300 and acquire the vehicle position information using the captured image.

The first time management unit 213 manages time t1 that is a time used in a process executed in the recognition server 200a. The time t1 is synchronized at a predetermined timing so as to be the same as the time t2 described later. When the information indicating the position and the direction of the vehicle 100 calculated by the calculation unit 212 is sent, the first time management unit 213 sends the information indicating the time t1 together with the information to the control server 200b. The first time management unit 213 may send not only information indicating the position and the direction of the vehicle 100 but also information indicating the time t1 when any information is sent from the recognition server 200a to another device. In addition, the first time management unit 213 may send the time t1 independently at any timing.

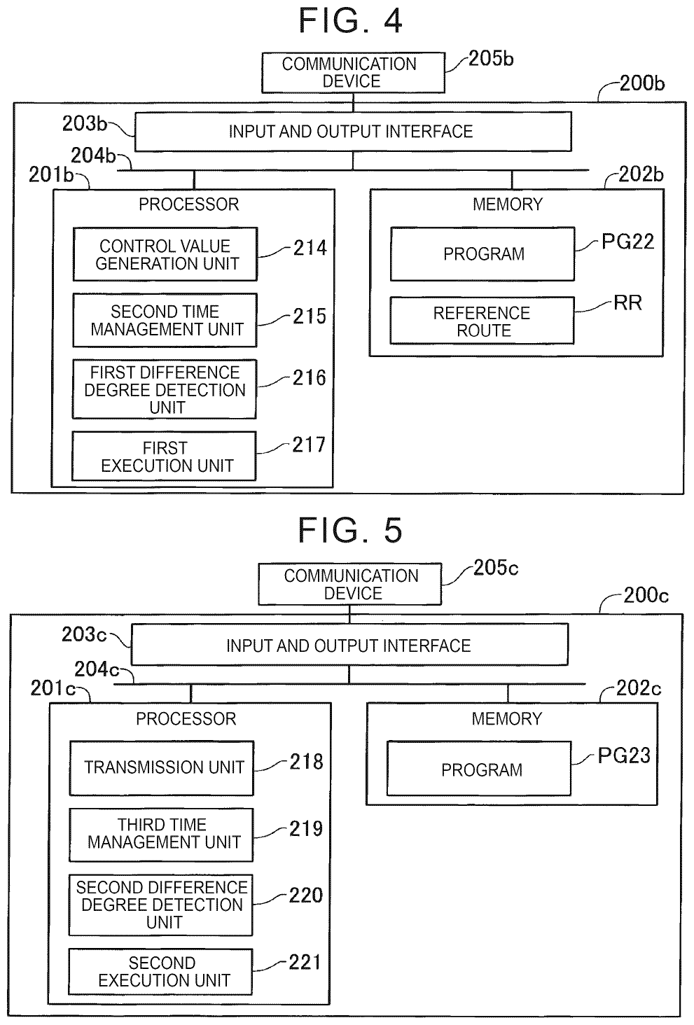

FIG. 4 is a diagram illustrating a configuration of a control server 200b according to the first embodiment. The control server 200b executes a process related to generation of a travel control signal for controlling the vehicle 100 among processes for controlling the unmanned driving of the vehicle 100. The control server 200b includes a computer including a processor 201b, a memory 202b, an input/output interface 203b, and an internal bus 204b. A communication device 205b for communicating with various devices outside the control server 200b is connected to the input/output interface 203b. The functions of the respective units constituting the control server 200b and the connecting modes between the respective units are the same as those of the recognition server 200a, and therefore, the explanation thereof is omitted.

The processor 201b functions as the control value generation unit 214, the second time management unit 215, the first difference degree detection unit 216, and the first execution unit 217 by executing the program PG22 stored in the memory 202b.

The control value generation unit 214 acquires the position and the direction of the vehicle 100 calculated by the calculation unit 212, and generates and outputs a travel control signal for controlling the actuator group 120 of the vehicle 100 by using the position and the direction of the vehicle 100. Note that the control value generation unit 214 may generate not only the travel control signal but also a control signal for controlling various accessories provided in the vehicle 100 and actuators for operating various kinds of equipment such as a wiper, a power window, and a lamp, for example. The travel control signal and the control signal correspond to the “control value” in the present disclosure.

The second time management unit 215 manages time t2 which is a time used in a process executed in the control server 200b. The time t2 is synchronized at a predetermined timing so as to be the same as the time to managed by the time management server 400 located outside the control server 200b. When the travel control signal generated by the control value generation unit 214 is sent, the second time management unit 215 sends information indicating the time t2 together with the travel control signal to the vehicle communication server 200c. Note that the second time management unit 215 may send not only the travel control signal generated by the control value generation unit 214 but also the information indicating the time t2 when any information is sent from the control server 200b to another device. Further, the second time management unit 215 may send the time t2 independently at any timing.

The time management server 400 is configured by a computer. The time management server 400 manages the absolute time as the time t0, and the actual time in the present embodiment. The time t0 is not limited to the absolute time, and may be a relative time, for example, an elapsed time since the time management server 400 starts operating. The time t0 may be any time available as a time stamp of various processes executed in the group of server group 200. In the present embodiment, the communication between the time management server 400 and another device is restricted so that only the control server 200b of the server group 200 can perform communication with the time management server 400. By limiting the server that performs communication with the time management server 400 to the control server 200b, it is possible to suppress the maintenance of the security of the time management server 400 and the network-connection of other devices.

The first difference degree detection unit 216 acquires the time t2 managed by the second time management unit 215 and time t1 received from the recognition server 200a, and detects the degree of difference between the time t2 and the time t1. Further, the first difference degree detection unit 216 acquires time t2 and time t3 to be described later, and detects the degree of difference between the time t2 and the time t3. In the present embodiment, the first difference degree detection unit 216 detects the magnitude of the difference between the time t2 and the time t1 and the magnitude of the difference between the time t2 and the time t3 as the degree of difference. The first execution unit 217 executes a warning to the administrator of the system 10 and a stop instruction to the vehicle 100 when the degree of difference is equal to or greater than a predetermined threshold. Here, the “administrator” is not limited to a person who supervises the management of the system 10, and includes a worker who performs a recovery work when any abnormality occurs in the system 10. The processing performed by the first difference degree detection unit 216 and the first execution unit 217 will be described later. The control server 200b including the first difference degree detection unit 216 and the first execution unit 217 corresponds to a “device” in the present disclosure.

FIG. 5 is a diagram illustrating a configuration of a vehicle communication server 200c according to the first embodiment. The vehicle communication server 200c executes a process for sending a travel control signal to the vehicle 100 among processes for controlling the unmanned driving of the vehicle 100. The vehicle communication server 200c includes a computer including a processor 201c, a memory 202c, an input/output interface 203c, and an internal bus 204c. A communication device 205c for communicating with various devices outside the vehicle communication server 200c is connected to the input/output interface 203c. The functions of the respective units constituting the vehicle communication server 200c and the connecting modes between the respective units are the same as those of the recognition server 200a, and therefore, the explanation thereof is omitted.

The processor 201c functions as the transmission unit 218, the third time management unit 219, the second difference degree detection unit 220, and the second execution unit 221 by executing the program PG23 stored in the memory 202c.

The transmission unit 218 acquires the travel control signal and sends the travel control signal to the vehicle 100. In the present embodiment, the unmanned driving of the vehicle 100 is realized by receiving the travel control signal sent from the transmission unit 218 to the vehicle 100.

The third time management unit 219 manages time t3 which is a time used in a process executed in the vehicle communication server 200c. The time t3 is synchronized at a predetermined timing so as to be the same as the time t2 described above. When the travel control signal is sent, the third time management unit 219 sends information indicating the time t3 to the control server 200b. The third time management unit 219 may send not only the travel control signal but also the information indicating the time t3 when the information is sent from the vehicle communication server 200c to another device.

The second difference degree detection unit 220 acquires the time t3 managed by the third time management unit 219 and the time t2 received from the control server 200b, and detects the degree of difference between the time t2 and the time t3. In the present embodiment, the second difference degree detection unit 220 detects the magnitude of the difference between the time t3 and the time t2 as the degree of difference between the time t3 and the time t2. When the degree of difference between the time t3 and the time t2 is equal to or larger than a predetermined threshold, the second execution unit 221 executes a warning to the administrator of the system 10 and a stopping instruction to the vehicle 100. The process performed by the second difference degree detection unit 220 and the second execution unit 221 will be described later. The vehicle communication server 200c including the second difference degree detection unit 220 and the second execution unit 221 corresponds to a “device” in the present disclosure.

### A-2. Drive Control:

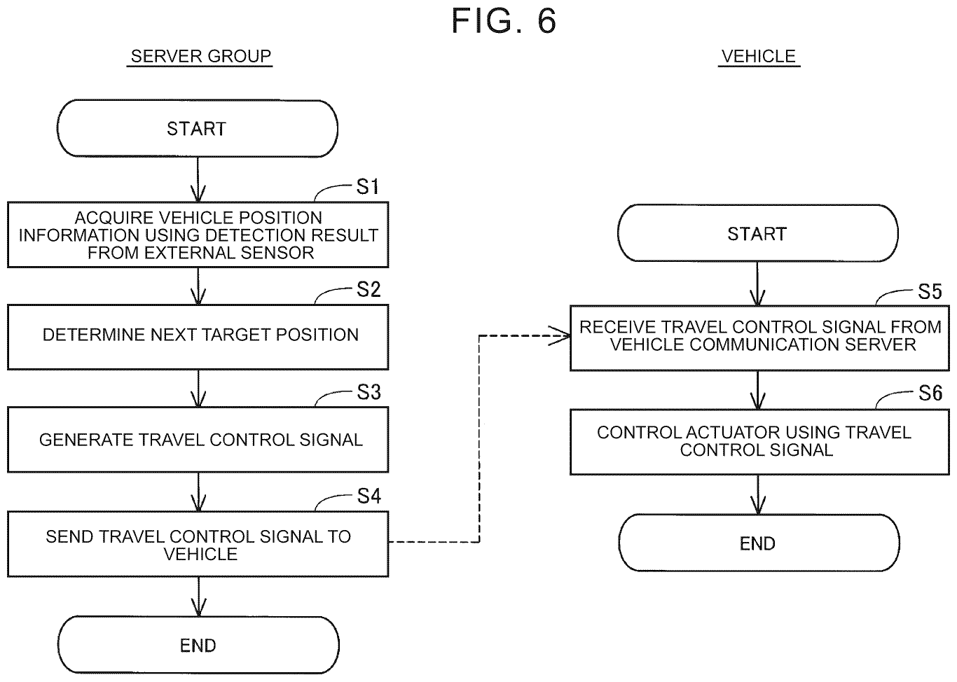

FIG. 6 is a flowchart illustrating a processing procedure of travel control of the vehicle 100 according to the first embodiment. In FIG. 6, a flow on the left side shows a process executed in the server group 200, and a flow on the right side shows a process executed in the vehicle 100. In the following description, processing by the processing unit 211 is omitted.

In S1, the calculation unit 212 acquires the vehicle position data of the vehicle 100 using the detection data outputted from the external sensor 300. The vehicle position information is position information that is a basis for generating a travel control signal. In the present embodiment, the vehicle position information includes the position and orientation of the vehicle 100 in the global coordinate system GC of the factory FC. Specifically, in S1, the calculation unit 212 acquires the vehicle position data using the captured images acquired from the cameras that are the external sensors 300.

Specifically, in S1, for example, the calculation unit 212 detects the external shape of the vehicle 100 from the captured images. Then, in S1, the calculation unit 212 calculates the coordinates of the positioning points of the vehicles 100 in the coordinate system of the captured images, that is, the local coordinate system. Then, in S1, the calculation unit 212 acquires the position of the vehicle 100 by converting the calculated coordinates into coordinates in the global coordinate system GC. The outline of the vehicle 100 included in the captured image can be detected by, for example, inputting the captured image into a detection model DM using artificial intelligence. The detection model DM is prepared in the system 10 or outside the system 10, for example, and stored in the memory 202a of the recognition server 200a in advance. The detection model DM may be, for example, a learned machine learning model learned to implement either semantic segmentation or instance segmentation. As the machine learning model, for example, a convolutional neural network (hereinafter, CNN) learned by supervised learning using a learning dataset can be used. The training data set includes, for example, a plurality of training images including the vehicle 100 and a label indicating which of the regions in the training image indicates the vehicle 100 and the regions other than the vehicle 100. When CNN is learned, the parameters of CNN are preferably updated by back propagation so as to reduce the error between the output-result and -label due to the detection model DM. Further, the calculation unit 212 can obtain the direction of the vehicle 100 by estimating the direction of the movement vector of the vehicle 100 calculated from the position change of the feature point of the vehicle 100 between the frames of the captured image using, for example, the optical flow method.

In S2, the control value generation unit 214 determines a target position at which the vehicles 100 are to be directed next. In the present embodiment, the target position is represented by the coordinates of X, Y, Z in the global coordinate system GC. In the memory 202b of the control server 200b, reference route RR that is a route on which the vehicle 100 should travel is stored in advance. The route is represented by a node indicating a starting point, a node indicating a passing point, a node indicating a destination, and a link connecting the respective nodes. The control value generation unit 214 determines a target position to which the vehicle 100 should be directed next, using the vehicle position information and the reference route RR. The control value generation unit 214 determines the target position on the reference route RR ahead of the current position of the vehicles 100.

In S3, the control value generation unit 214 generates a travel control signal for causing the vehicle 100 to travel toward the determined target position. The control value generation unit 214 calculates the traveling speed of the vehicle 100 from the transition of the position of the vehicle 100, and compares the calculated traveling speed with the target speed. As a whole, the control value generation unit 214 determines acceleration so that the vehicle 100 accelerates when the traveling speed is lower than the target speed, and determines acceleration so that the vehicle 100 decelerates when the traveling speed is higher than the target speed. When the vehicle 100 is located on the reference route RR, the control value generation unit 214 determines the steering angle and the acceleration so that the vehicle 100 does not deviate from the reference route RR. When the vehicle 100 is not located on the reference route RR, in other words, when the vehicle 100 deviates from the reference route RR, the control value generation unit 214 determines the steering angle and the acceleration so that the vehicle 100 returns to the reference route RR.

At S4, the transmission unit 218 sends the generated travel control signal to the vehicles 100. The server group 200 repeats the acquisition of the position of the vehicle 100, the determination of the target position, the generation of the travel control signal, the transmission of the travel control signal, and the like at predetermined intervals.

In S5, the vehicle control unit 115 receives a travel control signal sent from the vehicle communication server 200c. In S6, the vehicle control unit 115 controls the actuator group 120 using the received travel control signal, thereby causing the vehicle 100 to travel at the acceleration and the steering angle represented by the travel control signal. The vehicle control unit 115 repeats the reception of the travel control signal and the control of the actuator group 120 at a predetermined cycle. According to the system 10 of the present embodiment, the vehicle 100 can be driven by remote control, and the vehicle 100 can be moved without using a conveyance facility such as a crane or a conveyor.

### A-3. Processing in Server Group 200:

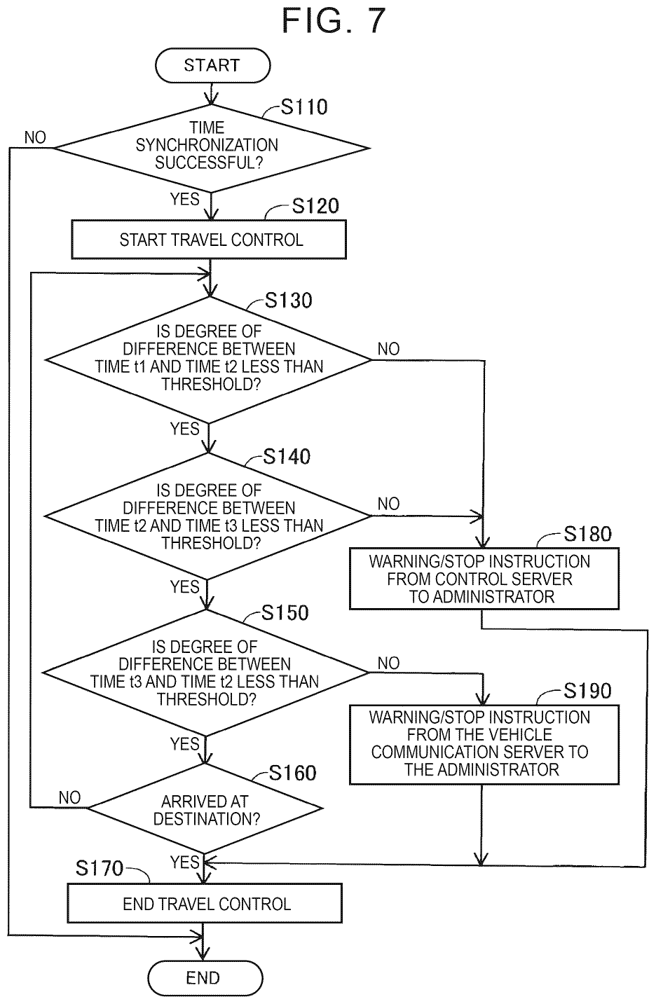

FIG. 7 is a flowchart illustrating a procedure of processing executed in the server group 200 according to the first embodiment. In the present embodiment, the above-described travel control is executed as the basic control, and the present processing is executed in combination with the travel control. This process is started when the start of the travel control is requested. For example, it is started when it is detected that the vehicle 100 has arrived at a predetermined position or when a start is requested by an operator.

In S110, the first time management unit 213, the second time management unit 215, and the third time management unit 219 each determine whether time synchronization is successful. More specifically, the first time management unit 213 determines whether synchronization between the time t1 and the time t2 is successful. The second time management unit 215 determines whether synchronization between the time t2 and the time t0 is successful. The third time management unit 219 determines whether synchronization between the time t3 and the time t2 is successful. When it is determined that the synchronization is not successful in at least one of the first time management unit 213, the second time management unit 215, and the third time management unit 219 (S110: No), the travel control is not started, and the process ends. This is because, if the synchronization is not successful, there is a possibility that a time lag occurs between the servers, and the accuracy of the remote control is deteriorated. At this time, the time management unit that has determined that the synchronization is not successful may notify the administrator of the system 10 to that effect.

When it is determined that the synchronization is successful in each of the first time management unit 213, the second time management unit 215, and the third time management unit 219 (S110: Yes), the above-described travel control is started in S120.

In S130, the first difference degree detection unit 216 acquires the time t1 and the time t2, and determines whether or not the degree of difference between the time t1 and the time t2 is less than a predetermined threshold. The thresholds in this step are set considering the times required for communication between the recognition server 200a and the control server 200b during normal times.

In S130, the first difference degree detection unit 216 corresponds to a “difference degree detection unit” in the present disclosure. The recognition server 200a corresponds to a “first control device” in the present disclosure. The time t1 corresponds to the “first time” in the present disclosure, the processing unit 211 and the calculation unit 212 correspond to the “first functional unit” in the present disclosure, and the first time management unit 213 corresponds to the “first time management unit” in the present disclosure. The control server 200b corresponds to a “second control device” in the present disclosure. The time t2 corresponds to the “second time” in the present disclosure, the control value generation unit 214 corresponds to the “second functional unit” in the present disclosure, and the second time management unit 215 corresponds to the “second time management unit” in the present disclosure.

When it is determined that the degree of difference between the time t1 and the time t2 is not less than the threshold (S130: No), in other words, when the degree of difference is equal to or greater than the threshold, in S180, the first execution unit 217 sends a warning to the administrator of the system 10 and a stop instruction to the vehicle 100. In the present embodiment, the first execution unit 217 sends an error signal indicating that an abnormality has occurred as a stop instruction to the vehicle 100. The vehicle control unit 115 stops traveling when an error signal is received. In S180, the first execution unit 217 corresponds to the “execution unit” in the present disclosure.

When it is determined that the degree of difference between the time t1 and the time t2 is less than the threshold (S130: Yes), the first difference degree detection unit 216 acquires the time t2 and the time t3 in S140 and determines whether the degree of difference between the time t2 and the time t3 is less than the predetermined threshold. The thresholds in this step are set considering the times required for communication between the control server 200b and the vehicle communication server 200c during normal times.

In S140, the first difference degree detection unit 216 corresponds to a “difference degree detection unit” in the present disclosure. The control server 200b corresponds to a “first control device” in the present disclosure. The time t2 corresponds to the “first time” in the present disclosure, the control value generation unit 214 corresponds to the “first functional unit” in the present disclosure, and the second time management unit 215 corresponds to the “first time management unit” in the present disclosure. The vehicle communication server 200c corresponds to a “second control device” in the present disclosure. The time t3 corresponds to the “second time” in the present disclosure, the transmission unit 218 corresponds to the “second functional unit” in the present disclosure, and the third time management unit 219 corresponds to the “second time management unit” in the present disclosure.

When it is determined that the degree of difference between the time t2 and the time t3 is not less than the threshold (S140: No), in other words, when the degree of difference is equal to or greater than the threshold, the above-described S180 is executed.

When it is determined that the degree of difference between the time t2 and the time t3 is less than the threshold (S140: Yes), the second difference degree detection unit 220 acquires the time t3 and the time t2 in S150 and determines whether the degree of difference between the time t3 and the time t2 is less than the predetermined threshold. The thresholds in this step are set considering the times required for communication between the vehicle communication server 200c and the control server 200b during normal times. In the above-described S140, the first difference degree detection unit 216 determines the difference between the time t2 and the time t3, but the second difference degree detection unit 220 performs the same determination even in S150, so that it is possible to more reliably ensure that the time synchronization between the servers is performed.

In S150, the second difference degree detection unit 220 corresponds to a “difference degree detection unit” in the present disclosure. The vehicle communication server 200c corresponds to a “first control device” in the present disclosure. The time t3 corresponds to the “first time” in the present disclosure, the transmission unit 218 corresponds to the “first functional unit” in the present disclosure, and the third time management unit 219 corresponds to the “first time management unit” in the present disclosure. The control server 200b corresponds to a “second control device” in the present disclosure. The time t2 corresponds to the “second time” in the present disclosure, the control value generation unit 214 corresponds to the “second functional unit” in the present disclosure, and the second time management unit 215 corresponds to the “second time management unit” in the present disclosure.

When it is determined that the degree of difference between the time t3 and the time t2 is not less than the threshold (S150: No), in other words, when the degree of difference is equal to or greater than the threshold, in S190, the second execution unit 221 sends a warning to the administrator of the system 10 and a stop instruction to the vehicle 100. In the present embodiment, the second execution unit 221 sends, as a stop instruction, a travel control signal instructing control for setting the travel speed of the vehicle 100 to 0 to the vehicle 100. In S190, the second execution unit 221 corresponds to the “execution unit” in the present disclosure.

If it is determined that the degree of difference between the time t3 and the time t2 is less than the threshold (S150: Yes), and if the vehicle 100 has not yet arrived at the destination (S160: No), the travel control is continued, and the above-described S130 is executed again. On the other hand, when the vehicles 100 arrive at the destination (S160: Yes), the travel control ends in S170. Thus, the present processing ends.

According to the system 10 of the first embodiment described above, the degree of difference between the time t1 and the time t2, the degree of difference between the time t2 and the time t3, and the degree of difference between the time t3 and the time t2 are detected, and when any of the degrees of difference is equal to or greater than the threshold, the administrator is warned and the stopping instruction is sent to the vehicle 100, so that the accuracy of the unmanned driving control can be suppressed from being deteriorated by continuing the control of the vehicle 100 with the large degree of difference.

In addition, it is possible to suppress deterioration in the accuracy of the unmanned driving control in the system 10 including the calculation unit 212, the control value generation unit 214, and the transmission unit 218.

In addition, a recognition server 200a, a control server 200b, and a vehicle communication server 200c are provided, and the servers have functional units that use different times. In such a system 10, it is possible to suppress a decrease in the accuracy of the unmanned driving control due to a difference in time that occurs between different servers.

### B. Second Embodiment

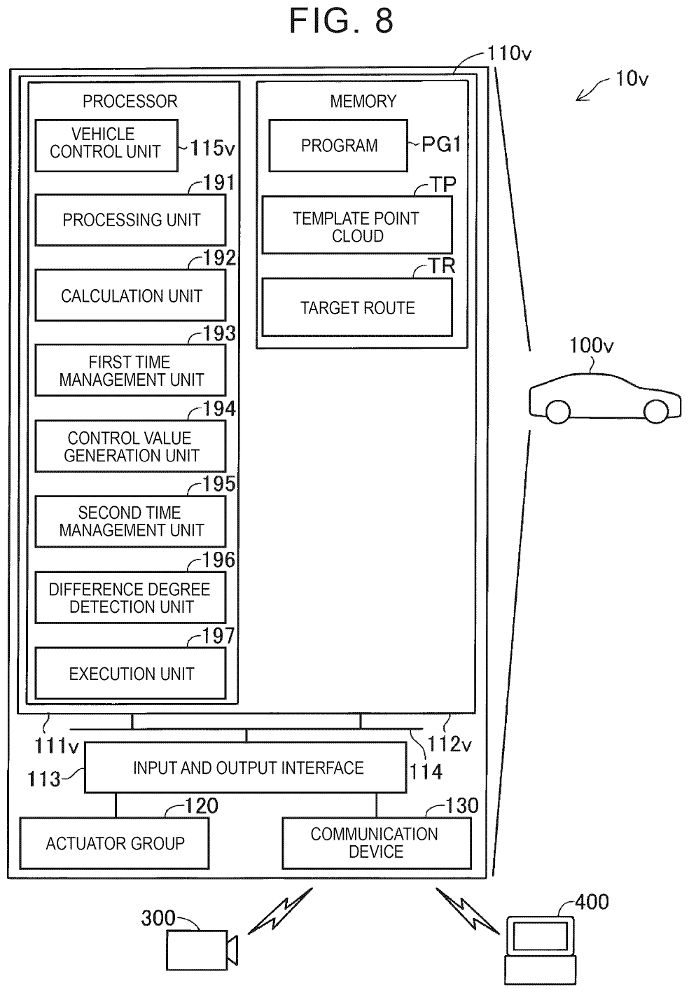

FIG. 8 is a block diagram illustrating a configuration of a system 10v according to the second embodiment. This embodiment differs from the first embodiment in that the system 10v does not include the server group 200. Further, the vehicle 100v according to the present embodiment can travel by autonomous control of the vehicle 100v. Other configurations are the same as those of the first embodiment unless otherwise described.

In the present embodiment, the processor 111v of the vehicle control device 110v functions as the vehicle control unit 115v, the processing unit 191, the calculation unit 192, the first time management unit 193, the control value generation unit 194, the second time management unit 195, the difference degree detection unit 196, and the execution unit 197 by executing the program PG1 stored in the memory 112v. The vehicle control unit 115v can cause the vehicle 100v to travel by autonomous control by acquiring a detection result by the sensor, generating a travel control signal using the detection result, and outputting the generated travel control signal to operate the actuator group 120. In the present embodiment, in addition to the program PG1, the detection model DM and the reference route RR are stored in advance in the memory 112v. The vehicle control device 110v in the second embodiment corresponds to the “device” in the present disclosure.

In the present embodiment, the first time management unit 193 manages time t1 used in the processing executed by the processing unit 191 and the calculation unit 192. The second time management unit 195 manages time t2 used in the process executed by the control value generation unit 194. The difference degree detection unit 196 acquires the time t1 managed by the first time management unit 193 and the time t2 managed by the second time management unit 195, respectively, and detects a difference between the time t1 and the time t2.

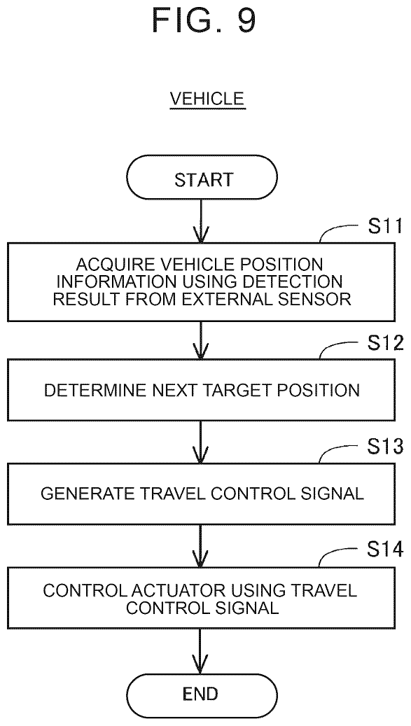

FIG. 9 is a flow chart showing a process sequence of travel control of the vehicle 100v according to the second embodiment. In the following description, processing by the processing unit 191 is omitted. In S11, the calculation unit 192 acquires the position information of the vehicle using the detection result outputted from the camera as the external sensor 300. In S11 according to the present embodiment, the processor 111v acquires the vehicle position data using the captured images and the vehicle speed as in S1 of FIG. 3. In S12, the control value generation unit 194 determines a target position at which the vehicle 100v is to be directed next. In S13, the control value generation unit 194 generates a travel control signal for causing the vehicle 100v to travel toward the determined target position. In S14, the vehicle control unit 115v controls the actuator group 120 by using the generated travel control signal, thereby causing the vehicle 100v to travel in accordance with the parameter represented by the travel control signal. The processor 111v repeats acquiring the vehicle position information, determining the target position, generating the travel control signal, and controlling the actuator group 120 at a predetermined cycle. According to the system 10v of the present embodiment, the vehicle 100v can be driven by the autonomous control of the vehicle 100v without remotely controlling the vehicle 100v by the server group 200.

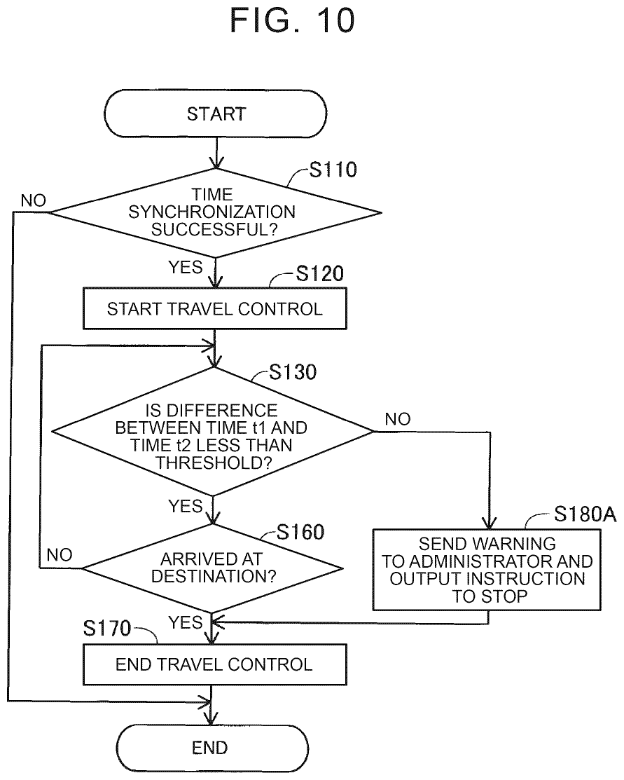

FIG. 10 is a flow chart showing a sequence of a process in the vehicle control device 110v according to the second embodiment. In the present embodiment, in S130, the difference degree detection unit 196 determines whether or not the degree of difference between the time t1 and the time t2 is less than a predetermined threshold.

In the present embodiment, the time t1 corresponds to the “first time” in the present disclosure, the processing unit 191 and the calculation unit 192 correspond to the “first functional unit” in the present disclosure, and the first time management unit 193 corresponds to the “first time management unit” in the present disclosure. Further, the time t2 corresponds to the “second time” in the present disclosure, the control value generation unit 194 corresponds to the “second functional unit” in the present disclosure, and the second time management unit 195 corresponds to the “second time management unit” in the present disclosure.

When it is determined that the degree of difference is not less than the threshold (S130: No), in other words, when the degree of difference is equal to or greater than the threshold, in S180A, the execution unit 197 sends a warning to the administrator and outputs a stopping signal to the vehicle control unit 115v. In the present embodiment, the execution unit 197 outputs, as the stop signal, at least one of an error signal indicating that an abnormality has occurred and a travel control signal instructing control for setting the travel speed of the vehicle 100 to 0. The vehicle control unit 115v stops traveling when an error signal is acquired. On the other hand, if the degree of difference between the time t1 and the time t2 is less than the thresholds (S130: Yes), the above-described S160 is executed.

According to the above system 10v of the second embodiment, the same advantages as those of the first embodiment can be obtained even when the vehicle 100v is driven by the autonomous control of the vehicle 100v.

### C. Other Embodiments

(C1) In the above embodiment, S130, S140 and S150 illustrated in FIG. 7 are executed in this order, but the present disclosure is not limited thereto. At least two steps out of S130, S140 and S150 may be performed in temporal parallel to each other. According to this embodiment, the same effects as those of the above embodiment can be obtained.

(C2) In the above embodiment, in S180 illustrated in FIG. 7, the first execution unit 217 sends an alert to the administrator and a stop instruction, but the present disclosure is not limited to this. The first execution unit 217 may send only one of the warning to the administrator and the stop instruction. Similarly, in S190, the second execution unit 221 may send only one of a warning to the administrator and a stopping instruction. According to such a configuration, as compared with a configuration in which no treatment is performed, it is possible to suppress the occurrence of a malfunction in the unmanned driving of the vehicle 100 by continuing the travel control in a state in which the time shift occurs.

(C3) In the above embodiment, the first execution unit 217 and the second execution unit 221 send a stop instruction instructing the vehicle 100 to stop traveling, but the present disclosure is not limited to this. The first execution unit 217 and the second execution unit 221 may send, to the vehicle 100, a deceleration instruction instructing to reduce the traveling speed of the vehicle 100, instead of the stop instruction. According to such a configuration, as compared with a configuration in which the vehicle 100 is driven at a normal speed even in a state where a time shift occurs, the travel distance of the vehicle 100 per unit time is shortened, so that it is possible to suppress a decrease in the accuracy of the unmanned driving control.

(C4) In the above-described embodiment, in S110 illustrated in FIG. 7, the time t2 is synchronized with the time to, and the time t1 and the time t3 are synchronized with the time t2. Instead of the time t2, the time t1 or the time t3 may be synchronized with the time t0. When both the recognition server 200a, the control server 200b, and the vehicle communication server 200c are configured to be capable of communicating with the time management server 400, both the time t1, the time t2, and the time t3 may be directly synchronized with the time t0. According to this embodiment, the same effects as those of the above-described embodiment can be obtained.

(C5) In the above embodiment, the system 10 includes the first difference degree detection unit 216 and the second difference degree detection unit 220 as functional units corresponding to the difference degree detection unit of the present disclosure, and includes the first execution unit 217 and the second execution unit 221 as functional units corresponding to the execution unit of the present disclosure, but the present disclosure is not limited thereto. The system 10 may include one of the difference degree detection unit and one of the execution units. For example, in the server group 200, any one of the recognition server 200a, the control server 200b, and the vehicle communication server 200c may include a difference degree detection unit and an execution unit. In addition, the system 10 may further include a recognition server 200a, a control server 200b, and other devices that differ from the vehicle communication server 200c, and the other devices may include a difference degree detection unit and an execution unit. The other device may be a device external to the vehicle 100 or may be a device mounted on the vehicle 100. The other device corresponds to the “device” in the present disclosure. According to this embodiment, the same effects as those of the above-described embodiment can be obtained.

(C6) In the first embodiment, the processing unit 211, the calculation unit 212, the first time management unit 213, the control value generation unit 214, the second time management unit 215, the first difference degree detection unit 216, the first execution unit 217, the transmission unit 218, the third time management unit 219, the second difference degree detection unit 220, and the second execution unit 221 are distributed among the recognition server 200a, the control server 200b, and the vehicle communication server 200c, but the present disclosure is not limited thereto. The above-described functional units may be implemented in the same server. Even in such a configuration, it is conceivable that a plurality of functional units executes processing using different times in the same server. According to this embodiment, the same effects as those of the above-described embodiment can be obtained.

In the second embodiment, the vehicle control unit 115v, the processing unit 191, the calculation unit 192, the first time management unit 193, the control value generation unit 194, the second time management unit 195, the difference degree detection unit 196, and the execution unit 197 are all implemented in the same processor 111v, but the present disclosure is not limited thereto. The above functional units may be implemented in a distributed manner among a plurality of processors when the vehicle control device 110v includes a plurality of processors. The above-described functional units may be distributed among a plurality of computers when the vehicle control device 110v is configured by a plurality of computers. According to this embodiment, the same effects as those of the above-described embodiment can be obtained.

(C7) In each of the above embodiments, the external sensor 300 is a camera. On the other hand, the external sensor 300 may not be a camera, and may be, for example, a distance measuring device. The distance measuring device may be, for example, a light detection and ranging (LiDAR). In this case, the detection result output by the external sensor 300 may be three-dimensional point cloud data representing the vehicle 100. In this case, the server group 200 or the vehicle 100 may acquire the vehicle position information by template matching using three-dimensional point cloud data as a detection result and reference point cloud data prepared in advance.

(C8) In the first embodiment, the server group 200 executes processing from acquisition of vehicle position information to generation of a travel control signal. On the other hand, at least a part of the processing from the acquisition of the vehicle position information to the generation of the travel control signal may be executed by the vehicle 100. For example, the following forms (1) to (3) may be used.

(1) The server group 200 may acquire the vehicle position information, determine a target position to which the vehicle 100 should be directed next, and generate a route from the current position of the vehicle 100 represented by the acquired vehicle position information to the target position. The server group 200 may generate a route to a target position between the current position and the destination, or may generate a route to the destination. The server group 200 may send the generated route to the vehicle 100. The vehicle 100 may generate a travel control signal so that the vehicle 100 travels on the route received from the server group 200, and control the actuator group 120 using the generated travel control signal.

(2) The server group 200 may acquire the vehicle position information and send the acquired vehicle position information to the vehicle 100. The vehicle 100 may determine a target position to which the vehicle 100 should be directed next, generate a route from the current position of the vehicle 100 represented by the received vehicle position information to the target position, generate a travel control signal so that the vehicle 100 travels on the generated route, and control the actuator group 120 using the generated travel control signal.

(3) In the above forms (1) and (2), an internal sensor may be mounted on the vehicle 100, and a detection result output from the internal sensor may be used for at least one of generation of a route and generation of a travel control signal. The internal sensor is a sensor mounted on the vehicle 100. The internal sensor may include, for example, a sensor that detects a motion state of the vehicle 100, a sensor that detects an operation state of each unit of the vehicle 100, and a sensor that detects an environment around the vehicle 100. Specifically, the inner sensor may include, for example, a camera, a LiDAR, a millimeter-wave radar, an ultrasonic sensor, a GPS sensor, an accelerometer, a gyroscope, and the like. For example, in the form (1), the server group 200 may acquire the detection result of the internal sensor and reflect the detection result of the internal sensor in the path when generating the path. In the form (1), the vehicle 100 may acquire the detection result of the internal sensor and reflect the detection result of the internal sensor in the travel control signal when generating the travel control signal. In the form (2), the vehicle 100 may acquire the detection result of the internal sensor and reflect the detection result of the internal sensor in the path when generating the path. In the form (2), the vehicle 100 may acquire the detection result of the internal sensor and reflect the detection result of the internal sensor in the travel control signal when generating the travel control signal.

(C9) In the second embodiment, an internal sensor may be mounted on the vehicle 100v, and a detection result outputted from the internal sensor may be used for at least one of generation of a route and generation of a travel control signal. For example, the vehicle 100v may acquire the detection result of the internal sensor and reflect the detection result of the internal sensor in the route when generating the route. The vehicle 100v may acquire the detection result of the internal sensor and reflect the detection result of the internal sensor in the travel control signal when generating the travel control signal.

(C10) In the above-described embodiment in which the vehicle 100 can travel by autonomous control, the vehicle 100 acquires the vehicle position information using the detection result of the external sensor 300. On the other hand, an internal sensor may be mounted on the vehicle 100, and the vehicle 100 may acquire vehicle position information using a detection result of the internal sensor, determine a target position to which the vehicle 100 should be directed next, generate a route from the current position of the vehicle 100 represented in the acquired vehicle position information to the target position, generate a travel control signal for traveling on the generated route, and control the actuator of the vehicle 100 using the generated travel control signal. In this case, the vehicle 100 can travel without using any detection result of the external sensor 300. Note that the vehicle 100 may acquire the target arrival time and the traffic jam information from the outside of the vehicle 100 and reflect the target arrival time and the traffic jam information on at least one of the route and the travel control signal. In addition, all of the functional configurations of the system 10 may be provided in the vehicle 100. That is, the process implemented by the system 10 in the present disclosure may be implemented by the vehicle 100 alone.

(C11) In the first embodiment, the server group 200 automatically generates a travel control signal to be sent to the vehicle 100. On the other hand, the server group 200 may generate a travel control signal to be sent to the vehicle 100 in accordance with an operation of an external operator located outside the vehicle 100. For example, an external operator may operate a control device including a display for displaying a captured image output from the external sensor 300, a steering for remotely controlling the vehicle 100, an accelerator pedal, a brake pedal, and a communication device for communicating with the server group 200 through wired communication or wireless communication, and the server group 200 may generate a travel control signal corresponding to an operation applied to the control device.

(C12) In each of the above-described embodiments, the vehicle 100 may have a configuration that can be moved by unmanned driving, and may be, for example, in the form of a platform having a configuration described below. Specifically, the vehicle 100 may include at least a control device that controls the travel of the vehicle 100 and actuators such as a drive device, a steering device, and a braking device in order to perform three functions of “running,” “turning,” and “stopping” by unmanned driving. When the vehicle 100 acquires information from the outside for unmanned driving, the vehicle 100 may further include a communication device. That is, in the vehicle 100 that can be moved by the unmanned driving, at least a part of the interior components such as the driver's seat and the dashboard may not be mounted, at least a part of the exterior components such as the bumper and the fender may not be mounted, and the body shell may not be mounted. In this case, the remaining components such as the body shell may be attached to the vehicle 100 until the vehicle 100 is shipped from the factory FC, or the remaining components such as the body shell may be attached to the vehicle 100 after the vehicle 100 is shipped from the factory FC while the remaining components such as the body shell are not attached to the vehicle 100. Each of the components may be mounted from any direction, such as the upper side, lower side, front side, rear side, right side or left side of the vehicle 100, each may be mounted from the same direction, or may be mounted from a different direction. It should be noted that the position determination can also be performed for the form of the platform in the same manner as the vehicle 100 according to the first embodiment.

(C13) The vehicle 100 may be manufactured by combining a plurality of modules. A module refers to a unit composed of one or more components grouped according to the configuration and function of the vehicle 100. For example, the platform of the vehicle 100 may be manufactured by combining a front module that constitutes a front portion of the platform, a central module that constitutes a central portion of the platform, and a rear module that constitutes a rear portion of the platform. The number of modules constituting the platform is not limited to three, and may be two or less, or may be four or more. In addition to or instead of the platform, a different part of the vehicle 100 from the platform may be modularized. Further, the various modules may include any exterior parts such as bumpers and grills, and any interior parts such as sheets and consoles. In addition, not only the vehicle 100 but also a moving object of an arbitrary mode may be manufactured by combining a plurality of modules. Such a module may be manufactured, for example, by joining a plurality of parts by welding, a fixture, or the like, or may be manufactured by integrally molding at least a part of the module as one part by casting. Molding techniques for integrally molding at least a portion of a module as one part are also referred to as gigacasting or megacasting. By using the gigacasting, each part of the moving object, which has been conventionally formed by joining a plurality of parts, can be formed as one part. For example, the front module, the central module, and the rear module described above may be manufactured using gigacasting.

(C14) Transporting the vehicle 100 by using the traveling of the vehicle 100 by the unmanned driving is also referred to as “self-propelled conveyance”. A configuration for realizing self-propelled conveyance is also referred to as a “vehicle remote control autonomous traveling conveyance system”. Further, a production method of producing the vehicle 100 by using self-propelled conveyance is also referred to as “self-propelled production”. In self-propelled manufacturing, for example, at least a part of conveyance of the vehicle 100 is realized by self-propelled conveyance in a factory FC that manufactures the vehicle 100.

(C15) In each of the above embodiments, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

The present disclosure is not limited to each of the above embodiments, and can be realized by various configurations without departing from the spirit thereof. For example, the technical features in the embodiments corresponding to the technical features in the respective embodiments described in the Summary can be appropriately replaced or combined in order to solve some or all of the above-described problems or to achieve some or all of the above-described effects. Further, when the technical features are not described as essential in the present specification, these can be deleted as appropriate.

What is claimed is:

1. A system comprising:
a plurality of functional units each configured to perform a process for controlling unmanned driving of a moving object;
a first time management unit configured to manage a first time that is used in a first functional unit, the first functional unit being part of the functional units;
a second time management unit configured to manage a second time that is used in a second functional unit, the second functional unit being a different one of the functional units from the first functional unit;
a difference degree detection unit configured to detect a degree of difference between the first time and the second time; and
an execution unit configured to execute either or both of the following operations when the degree of difference is equal to or larger than a predetermined threshold: warning an administrator, and reducing a moving speed of the moving object.

2. The system according to claim 1, wherein the functional units include
a calculation unit configured to acquire either or both of a position of the moving object and a direction of the moving object by using a detection result regarding the moving object acquired from an external sensor located outside the moving object,
a control value generation unit configured to generate, using either or both of the position of the moving object and the direction of the moving object, a control value for controlling the moving object, and
a transmission unit configured to send the control value to the moving object.

3. The system according to claim 1, further comprising a plurality of control devices, wherein:
a first control device that is one of the control devices includes the first functional unit; and
a second control device that is a different one of the control devices from the first control device includes the second functional unit.

4. A device that is used in the system according to claim 1, the device comprising:
the difference degree detection unit; and
the execution unit.

5. A moving object configured to travel by unmanned driving, the moving object comprising:
a plurality of functional units configured to control the unmanned driving;
a first time management unit configured to manage a first time that is used in a first functional unit, the first functional unit being part of the functional units;
a second time management unit configured to manage a second time that is used in a second functional unit, the second functional unit being a different one of the functional units from the first functional unit;
a difference degree detection unit configured to detect a degree of difference between the first time and the second time; and
an execution unit configured to execute either or both of the following operations when the degree of difference is equal to or larger than a predetermined threshold: warning an administrator, and reducing a moving speed of the moving object.

6. A control method for controlling a moving object in a system including a plurality of functional units each configured to perform a process for controlling unmanned driving of the moving object, the control method comprising:
detecting a degree of difference between a first time and a second time, the first time being a time that is used in a first functional unit, the first functional unit being part of the functional units, the second time being a time that is used in a second functional unit, and the second functional unit being a different one of the functional units from the first functional unit; and
executing either or both of the following operations when the degree of difference is equal to or larger than a predetermined threshold: warning an administrator, and reducing a moving speed of the moving object.
